(19) United States
(12) Patent Application Publication
(10) Pub. No.: US 2025/0044260 A1
(43) Pub. Date: Feb. 6, 2025

(54) STATE ESTIMATION SYSTEM AND METHOD

(71) Applicant: NIPPON TELEGRAPH AND TELEPHONE CORPORATION, Tokyo (JP)

(72) Inventors: Arinobu NIIJIMA, Tokyo (JP); Yuki KUBO, Tokyo (JP)

(73) Assignee: NIPPON TELEGRAPH AND TELEPHONE CORPORATION, Tokyo (JP)

(21) Appl. No.: 18/704,934

(22) PCT Filed: Nov. 5, 2021
(86) PCT No.: PCT/JP2021/040825

§ 371 Date: Apr. 26, 2024

(51) Int. Cl. G01N 29/24; G01N 29/34; G01N 29/46

(52) U.S. Cl. CPC G01N 29/2437; G01N 29/348; G01N 29/46; G01N 2291/102

(57) ABSTRACT

According to one aspect of this invention, upon estimating a contact state or a state of an object when a sensing unit is brought into contact with the object, a sensor device in which a first piezoelectric element and a second piezoelectric element are integrally configured in a state of being overlapped with each other is provided in the sensing unit. Then, an acoustic interface unit drives the first piezoelectric element to transmit a first sound wave and detects a reception signal corresponding to a second sound wave received by the second piezoelectric element in response to the transmission of the first sound wave, and an estimation device extracts a frequency feature amount from the reception signal and estimates a contact state of the sensing unit with the object or a state of the object on the basis of the extracted frequency feature amount.

### TECHNICAL FIELD

One aspect of this invention relates to a state estimation system and a state estimation method used to estimate, for example, a contact state or a state of an object at the time of contact with the object.

### BACKGROUND ART

In recent years, with development of robotics technology and the like, various sensing technologies have been proposed. One of these is, for example, a technique of estimating a contact state or a state of an object at the time of contact with the object. For example, Non Patent Literature 1 discloses a technique called active acoustic sensing using a sensor having a pair of piezo elements. In this technique, one of the piezo elements is used as a speaker and another is used as a microphone, an ultrasonic wave is transmitted from the speaker, this ultrasonic wave is received by the microphone, and a reception signal thereof is subjected to frequency analysis, thereby estimating a contact state or a state of an object when the sensor comes into contact with the object.

### CITATION LIST

### Non Patent Literature

Non Patent Literature 1: Ono, Makoto, Buntarou Shizuki, and Jiro Tanaka. “Touch & activate: adding interactivity to existing objects using active acoustic sensing.” Proceedings of the 26th annual ACM symposium on User interface software and technology. 2013.

### SUMMARY OF INVENTION

### Technical Problem

However, in the technique described in Non Patent Literature 1, the pair of piezo elements is disposed in a state of being separated from each other on a plane. For this reason, the size of the sensor is increased, and it is difficult to install the sensor in a sensing unit having a limited installation area, such as a finger of a person or a probe of a robot, for example.

This invention has been made in view of the above circumstances, and an object thereof is to provide a technique that can be installed in a small sensing unit having a limited installation area, and can estimate a state of an object with which the sensing unit is in contact with high accuracy.

### Solution to Problem

In order to solve the above problem, in one aspect of a state estimation system or a state estimation method according to this invention, upon estimating a contact state or a state of an object when a sensing unit is brought into contact with the object, a sensor device in which a first piezoelectric element and a second piezoelectric element are integrally configured in a state of being overlapped with each other is provided in the sensing unit. Then, an acoustic interface unit drives the first piezoelectric element to transmit a first sound wave and detects a reception signal corresponding to a second sound wave received by the second piezoelectric element in response to the transmission of the first sound wave, and an estimation device extracts a frequency feature amount from the reception signal and estimates a contact state of the sensing unit with the object or a state of the object on the basis of the extracted frequency feature amount.

According to one aspect of this invention, in the sensor device, since the first piezoelectric element and the second piezoelectric element are integrally configured in the state of being overlapped with each other, the size of the sensor device in a planar direction can be reduced as compared with a case where the piezoelectric elements are disposed side by side on a plane. For this reason, the sensor device can be installed in a sensing unit having a limited installation area, such as a finger of a person or a probe of a robot, for example.

In addition, since the first piezoelectric element and the second piezoelectric element are integrally configured, it is possible to efficiently receive the second sound wave in which the contact state or the state of the object is reflected with respect to the first sound wave transmitted from the first piezoelectric element without receiving large attenuation, and this makes it possible to estimate the contact state or the state of the object with high accuracy.

### Advantageous Effects of Invention

That is, according to one aspect of this invention, it is possible to provide a technique that can be installed in a small sensing unit having a limited installation area and can estimate a state of an object with which the sensing unit is in contact with high accuracy.

### BRIEF DESCRIPTION OF DRAWINGS

FIG. 1 is a diagram illustrating an overall configuration of a state estimation system according to a first embodiment of this invention.

FIG. 2 is a side view illustrating a configuration of a sensor device used in the state estimation system illustrated in FIG. 1.

FIG. 3 is a block diagram illustrating functional configurations of an acoustic interface unit and an estimation device used in the state estimation system illustrated in FIG. 1.

FIG. 4 is a flowchart illustrating an example of a processing procedure and processing contents of model learning processing performed by a control unit of the estimation device illustrated in FIG. 3.

FIG. 5 is a flowchart illustrating an example of a processing procedure and processing contents of state estimation processing performed by the control unit of the estimation device illustrated in FIG. 3.

FIG. 6 is a diagram illustrating an example of an estimation result of a state of a contact object by the state estimation system illustrated in FIG. 1.

FIG. 7 is a diagram illustrating an example of an estimation result of a contact state with respect to an object obtained by a system according to a second embodiment of this invention.

FIG. 8A is a graph illustrating an example of a power spectrum in all frequency bands of received sound waves measured in a state where the sensor device placed on “hard floor” is surrounded by a housing.

FIG. 8B is a graph illustrating and enlarging a power spectrum in a frequency band as a feature amount extraction target among characteristics illustrated in FIG. 8A.

FIG. 9A is a graph illustrating an example of a power spectrum in all frequency bands of received sound waves measured in a state where the sensor device placed on “soft floor” is surrounded by the housing.

FIG. 9B is a graph illustrating and enlarging a power spectrum in a frequency band as a feature amount extraction target among characteristics illustrated in FIG. 9A.

FIG. 10A is a graph illustrating an example of a power spectrum in all frequency bands of received sound waves measured under the same conditions in a state where the sensor device placed on “hard floor” is not surrounded by the housing.

FIG. 10B is a graph illustrating and enlarging a power spectrum in a frequency band as a feature amount extraction target among characteristics illustrated in FIG. 10A.

FIG. 11A is a graph illustrating an example of a power spectrum in all frequency bands of received sound waves measured under the same conditions in a state where the sensor device placed on “soft floor” is not surrounded by the housing.

FIG. 11B is a graph illustrating and enlarging a power spectrum in a frequency band as a feature amount extraction target among characteristics illustrated in FIG. 11A.

### DESCRIPTION OF EMBODIMENTS

Hereinafter, embodiments according to this invention will be described with reference to the drawings.

### First Embodiment

### Configuration Example

### (1) System

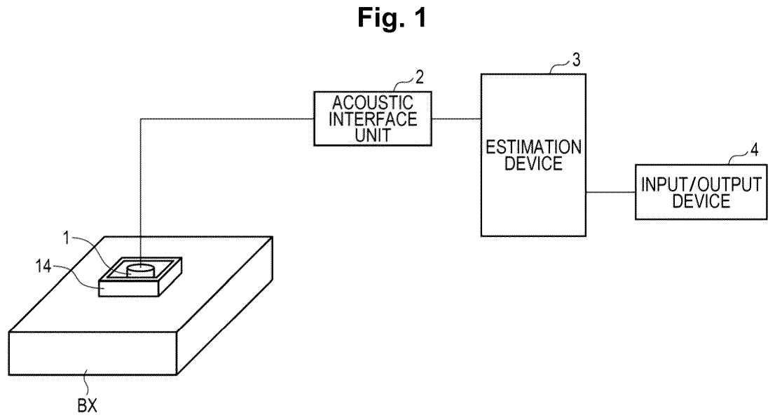

FIG. 1 is a diagram illustrating an example of an overall configuration of a state estimation system according to a first embodiment of this invention.

The state estimation system according to the first embodiment includes a sensor device 1, an acoustic interface unit 2, an estimation device 3, and an input/output device 4. The sensor device 1 is connected to the acoustic interface unit 2 via, for example, a signal cable, and the acoustic interface unit 2 is connected to the estimation device 3. The input/output device 4 is connected to the estimation device 3. The sensor device 1 is disposed in contact with an object BX. In this example, a case where the sensor device 1 is placed on, for example, a floor surface is illustrated.

### (2) Devices

### (2-1) Sensor Device 1

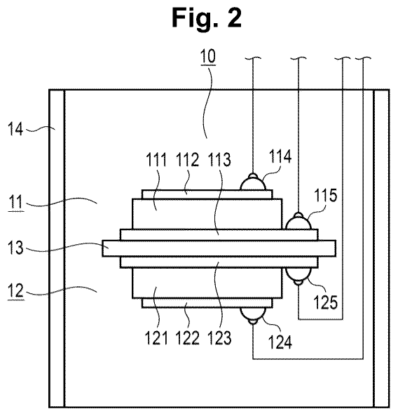

The sensor device 1 has a function as an active acoustic sensor, and is configured as follows, for example. FIG. 2 is a side view illustrating a configuration of the sensor device 1.

That is, the sensor device 1 includes a sensor 10 and a housing 14 disposed to surround the sensor 10 from all sides. In the sensor 10, a first piezoelectric element 11 for sound wave transmission and a second piezoelectric element 12 for sound wave reception are integrally formed in a back-to-back state with an insulating substrate 13 interposed therebetween.

In the first piezoelectric element 11, for example, a front electrode 112 and a back electrode 113 each having a plate shape or a sheet shape are disposed on both surfaces of a piezo element 111 having a plate shape or a sheet shape, and terminals 114 and 115 are provided on the front electrode 112 and the back electrode 113. The terminal 114, 115 receives a sound wave transmission signal output from the acoustic interface unit 2 via the signal cable.

Similarly to the first piezoelectric element 11, in the second piezoelectric element 12, for example, a front electrode 122 and a back electrode 123 each having a plate shape or a sheet shape are disposed on both surfaces of a piezo element 121 having a plate shape or a sheet shape, and terminals 124 and 125 are provided on the front electrode 122 and the back electrode 123. The terminal 124, 125 outputs a sound wave reception signal corresponding to a sound wave received by the piezo element 121 to the acoustic interface unit 2 via the signal cable.

The housing 14 is formed of, for example, a plastic frame, and is disposed to surround the sensor 10 from all sides in a state where the sensor 10 is directly placed on the object BX. Note that the housing 14 may be a box body whose upper surface is closed and lower surface is open, or may be a U-shaped frame body having no one side surface portion. In a case of the box body, a cut-away portion for leading out the signal cable of the sensor device 1 is provided in one side surface portion.

### (2-2) Acoustic Interface Unit 2

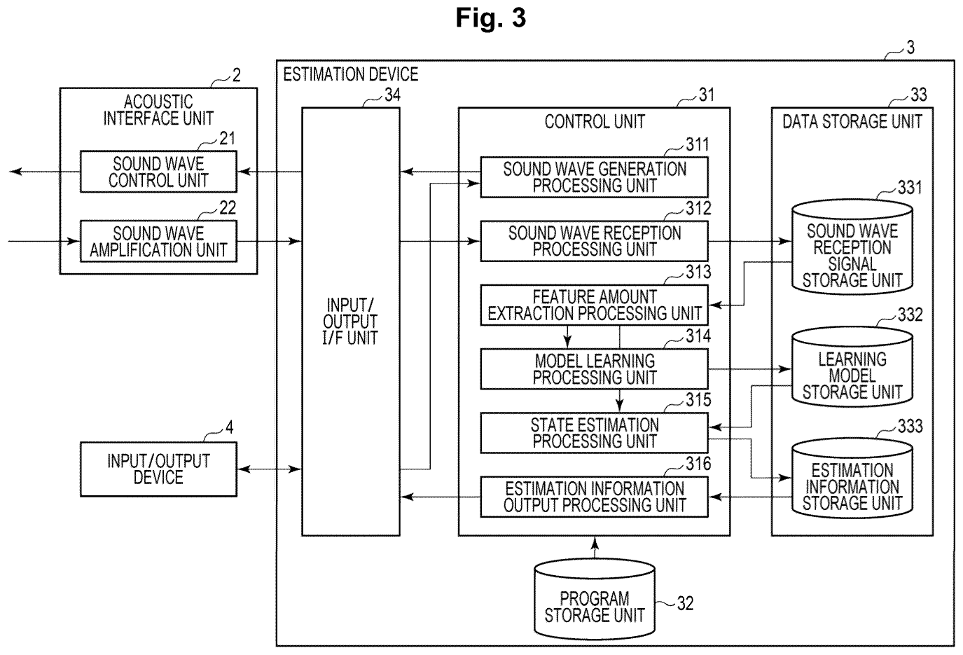

FIG. 3 is a block diagram illustrating functional configurations of the acoustic interface unit 2 and the estimation device 3.

The acoustic interface unit 2 includes a sound wave control unit 21 and a sound wave amplification unit 22. The sound wave control unit 21 controls transmission intensity of a sound wave transmission signal output from the estimation device 3 to be a preset value, and supplies the controlled sound wave transmission signal to the first piezoelectric element 11 of the sensor 10. The sound wave amplification unit 22 amplifies a sound wave reception signal output from the second piezoelectric element 12 of the sensor 10, and outputs the amplified sound wave reception signal to the estimation device 3.

### (2-3) Estimation Device 3

The estimation device 3 includes, for example, a personal computer. The estimation device 3 includes a control unit 31 using a hardware processor such as a central processing unit (CPU). Then, a storage unit including a program storage unit 32 and a data storage unit 33, and an input/output interface (hereinafter, the interface is referred to as an I/F) unit 34 are connected to the control unit 31 via a bus (not illustrated).

The acoustic interface unit 2 and the input/output device 4 are connected to the input/output I/F unit 34. The input/output device 4 includes an input unit including, for example, a keyboard and a mouse, and a display unit using, for example, a liquid crystal display or the like. The input/output device 4 is used to input various control data for controlling state estimation processing to the estimation device 3 and to display estimation information and the like output from the estimation device 3.

The program storage unit 32 is configured by combining, for example, a non-volatile memory capable of writing and reading as needed such as a solid state drive (SSD) and a non-volatile memory such as a read only memory (ROM) as a storage medium, and stores application programs necessary for executing various control processing according to the first embodiment in addition to middleware such as an operating system (OS). Note that, hereinafter, the OS and each application program are collectively referred to as a program.

The data storage unit 33 is, for example, a combination of non-volatile memory capable of writing and reading as needed such as an SSD and a volatile memory such as a random access memory (RAM) as a storage medium, and includes a sound wave reception signal storage unit 331, a learning model storage unit 332, and an estimation information storage unit 333 as main storage units necessary for implementing the first embodiment.

The sound wave reception signal storage unit 331 is used to store a sound wave reception signal received from the acoustic interface unit 2.

The learning model storage unit 332 stores a learning model to be used for estimating a state of the object BX from the sound wave reception signal. As the learning model, for example, a support vector machine (SVM) or the like adopting a supervised machine learning algorithm is used. However, the learning model is not limited thereto, and for example, a convolutional neural network (CNN) or the like may be used.

The estimation information storage unit 333 is used to store information indicating an estimation result of the state of the object BX obtained by the control unit 31.

The control unit 31 includes a sound wave generation processing unit 311, a sound wave reception processing unit 312, a feature amount extraction processing unit 313, a model learning processing unit 314, a state estimation processing unit 315, and an estimation information output processing unit 316 as processing functions necessary for implementing the first embodiment. Each of these processing units 311 to 316 is implemented by causing a hardware processor of the control unit 31 to execute an application program stored in the program storage unit 32. Note that the application program may be downloaded from, for example, a server computer or the like on a cloud as necessary, in addition to being stored in the program storage unit 32 in advance.

The sound wave generation processing unit 311 generates a sound wave transmission signal in accordance with an instruction input from the input/output device 4, and outputs the generated sound wave transmission signal from the input/output I/F unit 34 to the acoustic interface unit 2.

The sound wave reception processing unit 312 receives a sound wave reception signal output from the acoustic interface unit 2 via the input/output I/F unit 34, and stores the received sound wave reception signal in the sound wave reception signal storage unit 331.

The feature amount extraction processing unit 313 reads the sound wave reception signal from the sound wave reception signal storage unit 331 for a certain period of time and extracts a feature amount from the read sound wave reception signal. For example, a fast Fourier transform (FFT) is used to extract the feature amount, and a detailed operation will be described in an operation example.

In a learning mode set prior to actual estimation processing, the model learning processing unit 314 performs processing of constructing a learning model using the feature amount extracted from the sound wave reception signal as an explanatory variable and using, for example, a correct answer label of a state estimation result input by a system administrator as an objective variable.

In an estimation mode, the state estimation processing unit 315 performs processing of inputting the feature amount extracted from the sound wave reception signal to a learned learning model stored in the learning model storage unit 332, and storing a label output from the learning model as a result as information indicating an estimation result of a state in the estimation information storage unit 333.

After the end of the estimation processing, the estimation information output processing unit 316 performs processing of reading the information indicating the estimation result of the state from the estimation information storage unit 333, and outputting the read estimation information from the input/output I/F unit 34 to the input/output device 4.

### (Operation Example)

Next, an operation example of the device configured as described above will be described.

### (1) Learning Mode

The control unit 31 of the estimation device 3 executes learning processing of a learning model prior to state estimation processing. Note that, here, for example, a case where a learning model is constructed using “hard floor” made of wood or resin and “soft floor” on which a sheet such as cloth or urethane is laid as estimation targets will be described as an example.

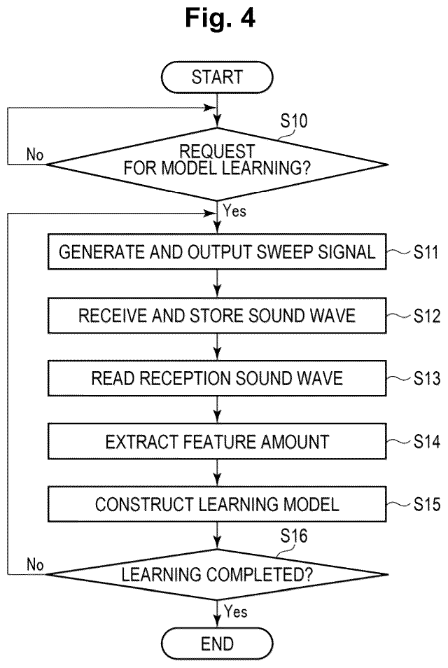

FIG. 4 is a flowchart illustrating an example of a processing procedure and processing contents of learning processing executed by the control unit 31 of the estimation device 3.

When a request for model learning processing is input from the input/output device 4 and detected in step S10, the control unit 31 of the estimation device 3 sets a learning mode. Then, in this state, first, under the control of the sound wave generation processing unit 311, in step S11, a sound wave transmission signal is generated, and the generated sound wave transmission signal is output from the input/output I/F unit 34 to the acoustic interface unit 2. Specifically, the sound wave generation processing unit 311 generates a sweep signal whose frequency changes in the range of 20-40 kHz, and outputs this sweep signal for 30 seconds corresponding to each of two types of estimation targets, that is, “hard floor” and “soft floor”.

On the other hand, when receiving the sweep signal, the acoustic interface unit 2 controls the sweep signal to have predetermined transmission intensity by the sound wave control unit 21. For example, the sound wave control unit 21 sets the sweep signal to have such an intensity that the sweep signal is determined by a rating of a piezo element and a sufficient sound wave reception level is obtained. Then, the sound wave control unit 21 supplies the sweep signal whose intensity is controlled to the first piezoelectric element 11 of the sensor device 1 as the sound wave transmission signal.

In the sensor device 1, when the sound wave transmission signal is supplied, the first piezoelectric element 11 vibrates to transmit a sound wave. Then, in response to the transmission of the sound wave, a sound wave reflecting a state of the object BX, for example, the hardness or softness of the floor is received by the second piezoelectric element 12, and a sound wave reception signal corresponding to the sound wave is input to the acoustic interface unit 2.

In the acoustic interface unit 2, the sound wave reception signal is amplified by the sound wave amplification unit 22, and the amplified sound wave reception signal is output to the estimation device 3. At this time, an amplification degree is set to an optimum value for the estimation device 3 to convert the sound wave reception signal into a digital signal, for example.

First, in step S12, under the control of the sound wave reception processing unit 312, the control unit 31 of the estimation device 3 takes in the sound wave reception signal converted into the digital signal by the input/output I/F unit 34, and stores this sound wave reception signal in the sound wave reception signal storage unit 331. Note that, at this time, a sampling rate of the sound wave reception signal is set to 96 kHz, for example.

Next, under the control of the feature amount extraction processing unit 313, the control unit 31 of the estimation device 3 reads the sound wave reception signal from the sound wave reception signal storage unit 331 for a certain period of time in step S13, and inputs the read sound wave reception signal to an FFT in step S14 to convert the sound wave reception signal into data in a frequency domain. For example, the feature amount extraction processing unit 313 reads the sound wave reception signal by 8192 samples and converts the sound wave reception signal into a power spectrum by the FFT. Then, the feature amount extraction processing unit 313 generates a feature amount vector from the power spectrum.

Subsequently, under the control of the model learning processing unit 314, in step S15, the control unit 31 of the estimation device 3 constructs a learning model using the feature amount vector as an explanatory variable and using, for example, a correct answer label input from the input/output device 4 by the system administrator as an objective variable. In this example, “hard floor” is set as the correct answer label for the feature amount vector obtained in the first 30 seconds, and “soft floor” is set as the correct answer label for the feature amount vector obtained in the following 30 seconds.

Finally, in step S16, the control unit 31 of the estimation device 3 determines whether or not the learning processing of the learning model has been completed, and if not completed, returns to step S11 to continue the learning processing of the learning model, and if completed, ends the learning processing.

### (2) Estimation Mode

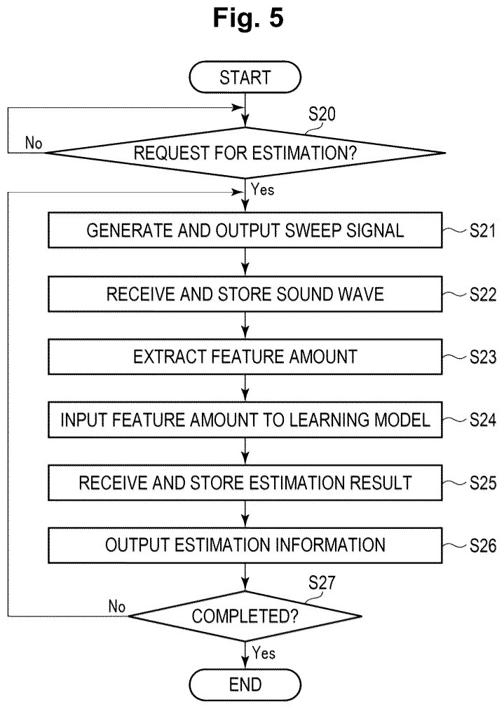

FIG. 5 is a flowchart illustrating an example of a processing procedure and processing contents of estimation processing executed by the control unit 31 of the estimation device 3.

When a request for estimation processing is input from the input/output device 4 and detected in step S20, the control unit 31 of the estimation device 3 sets an estimation mode. Then, in this state, first, under the control of the sound wave generation processing unit 311, in step S21, a sound wave transmission signal is generated, and the generated sound wave transmission signal is output from the input/output I/F unit 34 to the acoustic interface unit 2. Also in this case, as in the case of the learning mode, the sound wave generation processing unit 311 generates a sweep signal whose frequency changes in the range of 20-40 kHz, and outputs this sweep signal for a certain period of time.

Then, the sound wave transmission signal is controlled by the sound wave control unit 21 in the acoustic interface unit 2 so that intensity becomes a predetermined value, and is then supplied to the first piezoelectric element 11 of the sensor device 1.

In the sensor device 1, when the sound wave transmission signal is supplied, the first piezoelectric element 11 vibrates to transmit a sound wave. Then, in response to the transmission of the sound wave, a sound wave reflecting a state of the object BX on which the sensor device 1 is placed, for example, hardness or softness is received by the second piezoelectric element 12, and a sound wave reception signal corresponding to the sound wave is output to the acoustic interface unit 2.

In the acoustic interface unit 2, the sound wave reception signal is amplified by the sound wave amplification unit 22, and the amplified sound wave reception signal is output to the estimation device 3.

First, in step S22, under the control of the sound wave reception processing unit 312, the control unit 31 of the estimation device 3 takes in the sound wave reception signal converted into a digital signal by the input/output I/F unit 34, and stores the sound wave reception signal in the sound wave reception signal storage unit 331. Note that, in this case as well, the sound wave reception signal is sampled at a sampling rate of 96 kHz as in the learning.

Next, under the control of the feature amount extraction processing unit 313, the control unit 31 of the estimation device 3 reads the sound wave reception signal from the sound wave reception signal storage unit 331 for a certain period of time, for example, 8192 samples at a time in step S23, and inputs the read sound wave reception signal to the FFT to obtain a power spectrum. Then, the feature amount extraction processing unit 313 generates a feature amount vector from the power spectrum, and outputs the generated feature amount vector to the state estimation processing unit 315.

When the feature amount vector is input, the state estimation processing unit 315 inputs the feature amount vector to a learning model as an explanatory variable in step S24. As a result, an estimation result (estimated label) corresponding to the feature amount vector is output from the learning model.

For example, if the sensor device 1 is currently placed on “hard floor”, a label representing “hard floor” is output as the estimation result. Further, if the sensor device 1 is placed on “soft floor”, a label indicating “soft floor” is output as the estimation result.

The state estimation processing unit 315 receives information indicating the estimation result output from the learning model and stores the information in the estimation information storage unit 333 in step S25.

Under the control of the estimation information output processing unit 316, in step S26, the control unit 31 of the estimation device 3 reads the information indicating the estimation result from the estimation information storage unit 333, and outputs the read information indicating the estimation result from the input/output I/F unit 34 to the input/output device 4. As a result, in the input/output device 4, the information indicating the estimation result, for example, information indicating “hard floor” or “soft floor” is displayed on, for example, the display unit.

Finally, in step S27, the control unit 31 of the estimation device 3 determines whether or not the estimation processing of the learning model has been completed, and if not completed, returns to step S21 to continue the estimation processing, and if completed, ends the estimation processing.

### (Actions and Effects)

As described above, in the first embodiment, the sensor device 1 has a structure in which the first piezoelectric element 11 used as a speaker and the second piezoelectric element 12 used as a microphone are integrated back to back.

Therefore, the size of the sensor device 1 in a planar direction can be reduced as compared with a case where the piezoelectric elements 11 and 12 are disposed side by side on a plane, for example. For this reason, the sensor device can be installed in a sensing unit having a limited installation area, such as a finger of a person or a probe of a robot, for example.

In addition, in the first embodiment, the estimation device 3 first constructs a learning model in which a feature amount vector of a power spectrum extracted from a sound wave reception signal received by the sensor device 1 and a correct answer label of a state of the object BX corresponding thereto are respectively used as an explanatory variable and an objective variable in a learning mode, and estimates the state of the object BX by extracting a feature amount from the sound wave reception signal received by the sensor device 1 and inputting the feature amount to the learning model in an estimation mode.

Therefore, with the structure in which the first piezoelectric element 11 and the second piezoelectric element 12 are integrated, a sound wave reflecting the state of the object BX can be efficiently received without receiving large attenuation, and the state of the object BX can be estimated with high accuracy.

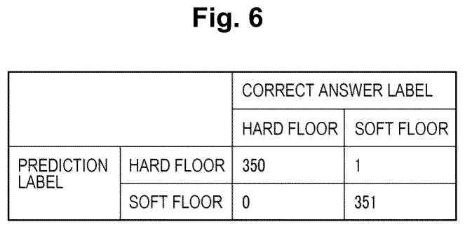

FIG. 6 illustrates an example of a result of estimating a state of a floor by placing the sensor device 1 on each of “hard floor” and “soft floor” under the conditions described in the first embodiment. As illustrated in FIG. 6, an accuracy rate of a prediction label output from a learning model is 99% in a case of “hard floor” and 100% in a case of “soft floor”, and it has been confirmed that the state of the floor can be estimated with high accuracy by this system.

Furthermore, in the first embodiment, the sensor device 1 is surrounded by the housing 14 in a state where the sensor device 1 is placed on the floor which is the object BX. In this way, a reception frequency characteristic of a sound wave can be improved in both the cases of “hard floor” and “soft floor”.

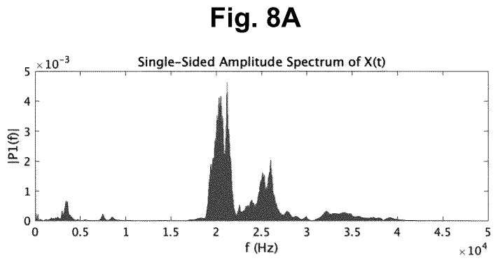

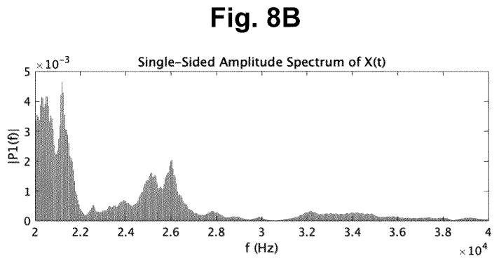

FIG. 8A is a graph illustrating an example of a power spectrum in all frequency bands of received sound waves measured in a state where the sensor device 1 placed on “hard floor” is surrounded by the housing 14, and FIG. 8B is a graph illustrating and enlarging a power spectrum in a frequency band as a feature amount extraction target.

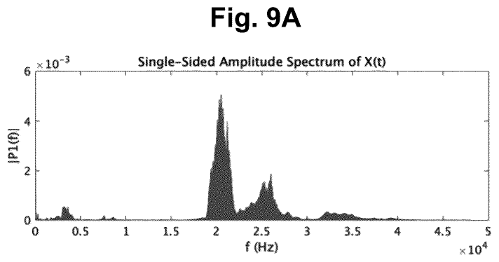

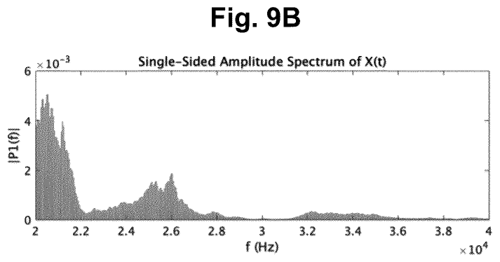

Further, FIG. 9A is a graph illustrating an example of a power spectrum in all frequency bands of received sound waves similarly measured in a state where the sensor device 1 placed on “soft floor” is surrounded by the housing 14, and FIG. 9B is a graph illustrating and enlarging a power spectrum in a frequency band as a feature amount extraction target.

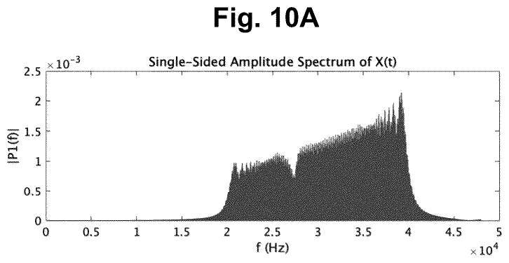

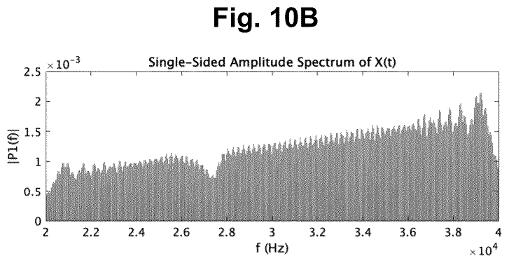

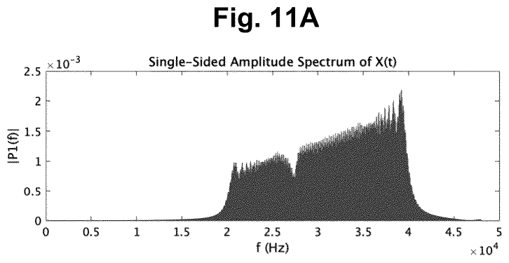

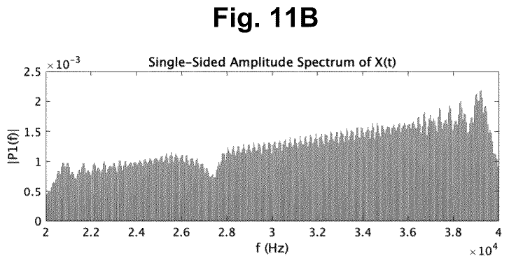

Incidentally, FIGS. 10A and 10B are graphs illustrating an example of a power spectrum in all frequency bands of received sound waves and that in a frequency band as a feature amount extraction target, which have been measured under the same conditions in a state where the sensor device 1 placed on “hard floor” is not surrounded by the housing 14. In addition, FIGS. 11A and 11B are graphs illustrating an example of a power spectrum in all frequency bands of received sound waves and that in a frequency band as a feature amount extraction target, which have been measured under the same conditions in a state where the sensor device 1 placed on “soft floor” is not surrounded by the housing 14.

As is clear from comparison between these drawings, even when the sensor device 1 is placed on “hard floor” or “soft floor”, it is possible to make a change in acoustic characteristics with respect to the floor which is the object BX remarkable by surrounding the sensor device 1 with the housing 14. That is, by surrounding the sensor device 1 with the housing 14, further improvement in estimation accuracy can be expected.

### Second Embodiment

In the first embodiment, a case of estimating whether a state is “hard” or “soft” with “floor” as an estimation target has been described as an example. However, the present invention is not limited thereto, and for example, a contact state with respect to an object may be estimated.

For example, in a case where the sensor device 1 is worn on a thenar muscle of the back of a right hand of a person and a rod-shaped object BX is gripped in this state, by using the system of this invention, it is possible to estimate “a case of strongly gripped” and “a case of weakly gripped” from a difference in acoustic characteristics. Also in this case, similarly to the first embodiment described above, by constructing a learning model in advance in a learning mode, it is possible to estimate a contact state with respect to the target object BX, that is, “strongly gripped” or “weakly gripped”. It is assumed that hardness of the thenar muscle of the person's hand changes depending on his/her grip strength, and the acoustic characteristics change according to this change, whereby strength of a gripped state can be estimated.

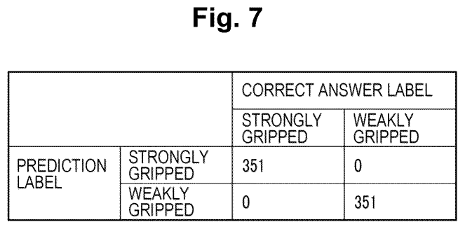

FIG. 7 illustrates an example of a result of estimating “a case where the rod-shaped object BX is strongly gripped” and “a case where the rod-shaped object BX is weakly gripped” in a state where the sensor device 1 is mounted on a thenar muscle of a person's hand. As illustrated in FIG. 7, an accuracy rate of a prediction label output from a learning model is 100% in both “case of strongly gripped” and “case of weakly gripped”, and it has been confirmed that a floor state can be estimated with high accuracy also for a contact state of the object BX by using the system according to this invention.

### Other Embodiments

(1) In the first embodiment, a case where the estimation result is displayed on the display unit of the input/output device 4 has been described as an example. However, the present invention is not limited to this, and for example, it may be transmitted from a communication interface unit to a terminal or the like at a remote location via a network and displayed.

(2) A case where the sensor device 1 is placed on the floor which is the object BX and the hardness of the floor is estimated in the first embodiment, and a case where the strength of the grip when the sensor device is worn on the finger and the object is gripped is estimated in the second embodiment have been described as examples. However, in addition to this, for example, the sensor device according to this invention may be attached to a portion corresponding to a hand of a robot or a probe. Accordingly, strength of a grip when the robot grips an object, hardness of the object when the object is pressed, and the like may be estimated.

(3) The estimation device may be configured by a server computer disposed on the Web or a cloud. In this case, for example, a terminal such as a personal computer or a smartphone is connected to the acoustic interface unit 2, and a sound wave transmission signal and a sound wave reception signal are transmitted to and from the server computer via the terminal. Further, operation information by a user is transmitted from the terminal to the server computer, and estimation information obtained by the estimation device is received by the terminal and displayed on the display unit.

(4) In addition, the structure of the sensor of the sensor device, the structure of the housing surrounding the sensor, the function, the processing procedure, the processing contents, and the like of the estimation device can be variously modified and implemented without departing from the gist of this invention, and any type, shape, material, and the like of an estimation target in a state or an object to be the estimation target in a contact state may be employed.

Although the embodiments of this invention have been described in detail above, the above description is merely an example of this invention in all respects. It is needless to say that various improvements and modifications can be made without departing from the scope of this invention. That is, a specific configuration according to the embodiments may be appropriately adopted to carry out this invention.

In short, this invention is not limited to the above-described embodiments without any change, and can be embodied by modifying the constituent elements without departing from the concept of the invention at the implementation stage. In addition, various inventions can be formulated by appropriately combining a plurality of the constituent elements disclosed in the above-described embodiments. For example, some constituent elements may be omitted from the entire constituent elements described in the embodiments. Furthermore, the constituent elements in different embodiments may be appropriately combined.

### REFERENCE SIGNS LIST

1 Sensor device
2 Acoustic interface unit
3 Estimation device
4 Input/output device
10 Sensor
11 First piezoelectric element
12 Second piezoelectric element
13 Insulating substrate
14 Housing
21 Sound wave control unit
22 Sound wave amplification unit
111, 121 Piezo element
112, 122 Front electrode
113, 123 Back electrode
114, 115, 124, 125 Terminal
31 Control unit
32 Program storage unit
33 Data storage unit
34 Input/output I/F unit
311 Sound wave generation processing unit
312 Sound wave reception processing unit
313 Feature amount extraction processing unit
314 Model learning processing unit
315 State estimation processing unit
316 Estimation information output processing unit
331 Sound wave reception signal storage unit
332 Learning model storage unit
333 Estimation information storage unit

1. A state estimation system that estimates a contact state or a state of an object when a sensing unit is brought into contact with the object, the state estimation system comprising:
a sensor in the sensing unit, in which a first piezoelectric element and a second piezoelectric element are integrally disposed in a state of overlapping each other;
an acoustic interface that drives the first piezoelectric element to transmit a first sound wave and detects a reception signal corresponding to a second sound wave received by the second piezoelectric element in response to the transmission of the first sound wave; and
estimation circuitry that extracts a feature amount from the reception signal and estimates a contact state of the sensing unit with the object or a state of the object based on the extracted feature amount.

2. The state estimation system according to claim 1, wherein;
the sensor is formed by integrating the first piezoelectric element and the second piezoelectric element in a state where the piezoelectric elements are mutually disposed back to back.

3. The state estimation system according to claim 1, wherein the sensor further includes:
a housing disposed to surround the first piezoelectric element and the second piezoelectric element that are integrated.

4. The state estimation system according to claim 1, wherein:
the estimation circuitry further includes a sound wave generator that generates a sweep signal whose frequency changes in a preset range and supplies the generated sweep signal to the acoustic interface to drive the first piezoelectric element.

5. The state estimation system according to claim 1, wherein:
the estimation circuitry converts the reception signal into a frequency domain signal by fast Fourier transform processing every predetermined time, and generates a feature amount vector from a power spectrum of the converted frequency domain signal.

6. A state estimation method for estimating a contact state or a state of an object, the state estimation method comprising:
supplying a drive signal from an acoustic interface to a sensor in which a first piezoelectric element and a second piezoelectric element are integrally disposed in a state of overlapping each other, and causing the first piezoelectric element to transmit a first sound wave;
detecting a reception signal corresponding to a second sound wave received by the second piezoelectric element in response to the transmission of the first sound wave by the acoustic interface; and
extracting a feature amount from the reception signal and estimating a contact state of a sensor with the object or a state of the object based on the extracted feature amount.
